(19) United States
(12) Patent Application Publication
(10) Pub. No.: US 2021/0363057 A1
(43) Pub. Date: Nov. 25, 2021

(54) NOVEL METHOD OF PRODUCING IMPROVED LIGHTWEIGHT CERAMIC SAND AND USES THEREOF

(71) Applicant: Abbas Khan, Zwickau (DE)

(72) Inventor: Abbas Khan, Zwickau (DE)

(21) Appl. No.: 17/393,506

(22) Filed: Aug. 4, 2021

Related U.S. Application Data
(63) Continuation-in-part of application No. 16/531,021, filed on Aug. 3, 2019, now abandoned.
(60) Provisional application No. 62/714,677, filed on Aug. 4, 2018.

(51) Int. Cl. C04B 18/02; C04B 28/02

(52) U.S. Cl. CPC C04B 18/027; C04B 18/021; C04B 18/023; C04B 2111/40; C04B 2201/30; C04B 2201/20; C04B 28/02

(57) ABSTRACT

The present invention discloses a novel, improved, simple and economic process for manufacturing lightweight ceramic sand. The lightweight ceramic sand is produced from the industrial wastes, wherein the major raw materials are fly ash, bauxite residue and biomass-coal fly ash. The present invention relates to the production of new fine particulates at high throughput and at low manufacturing cost to provide an alternative or substitute to the fast-depleting natural sand including crushed stones and lightweight fine aggregates produced from expanded clay, expanded glass and volcanic activities. Lightweight ceramic sand of the present invention can be used as a building and construction material and foundry sand.

### CROSS REFERENCE TO RELATED APPLICATIONS

This application is a continuation-in-part of a U.S. patent application Ser. No. 16/531,021 filed on Aug. 3, 2019, which claims priority to U.S. Provisional Patent Application No. 62/714,677 filed on Aug. 4, 2018, all of which are incorporated herein by reference in their entireties.

### FIELD OF THE INVENTION

The present invention relates to a method of producing new and improved lightweight ceramic sand, and more particularly relates to the novel method of producing new lightweight ceramic sand directly from fly ash, bauxite residue and/or biomass coal fly ash.

### BACKGROUND OF THE INVENTION

Sand is one of the most utilized natural resources, but the rapid depletion of sand has resulted into the global sand crisis. The high demand for good quality sand in construction and other industries is increasing the pressure on the dwindling natural sand sources. Annual production and consumption of sand outstrips nature's ability to generate sand by a factor of two. The sand particulates are high-volume consumption building material and an essential component of the construction industry. Currently, 40 billion tonnes of sand consumed worldwide of which 30 billion tonnes are used in the concrete and mortars production. The rapid urbanization puts growing pressure for supply from natural sand deposits in mostly ecologically fragile environments. Natural sand takes millions of years to form and is fast depleting. The extreme high consumption of sand has endangered coastal lines and 30 islands disappearance in the South East Asia.

There is a need to address the above mentioned issue by providing an alternative of natural sand. The best solution is to produce the sand particles from the industrial by-products generated in enormous quantity which cause a serious environmental and safety problems. Two of such industrial by-products are bauxite residue and fly ash.

Bauxite residue, commonly called red mud is largest waste by-product generated from the Bayer process in converting bauxite ore into alumina. Currently, about 125 million tonnes of bauxite residue are produced worldwide. On average less than 3% of the bauxite residue produced is utilized, while most of the remaining 97% is dumped into mud ponds (lagoons), increasing the threat to the local environment. Bauxite residue presents a huge problem as it takes up large land areas which can neither be built on nor farmed—even when dry. An adequate storage and disposal solution for bauxite residue is very costly. As additional environmental legislation and industrial restrictions develop, the costs for adequate storage and disposal solutions continue to increase.

Further, fly ash is a by-product obtained by burning coal in coal fired power stations. Currently, about 1,100 million tonnes of fly ash is produced worldwide. On average about 55% of the fly ash produced is utilized, while most of the remaining 45% is dumped into ash ponds (lagoons) and dry stacking, increasing the threat to the local environment. While trying to minimize the environmental impact by production of fly ash as wastage, various uses of fly ash have been contemplated to both aids in fly ash disposal and to obtain some viable utility and economic return from the same.

There is an urgent need to address the issues from disposal of bauxite residue and fly ash. At the same time we are facing tremendous scarcity of natural sand due to heavy demand in ever growing construction activities which has forced research and development to find a suitable substitute. Hence, this would be an effective way to use such by-products for producing sand in order to deal with its storage/disposal problems.

Various prior arts have been disclosed to overcome the above mentioned issues. The prior art document CN101575503A discloses use of red mud as a starting material for the production of propellants. Herein, red mud in a quantity between 1-20 wt % is used in combination with other waste components like ceramic roller waste material or fly ash.

Another prior art by Tian, X. et al describe in CN101085914A and in “The exploration of making acid proof fracturing propellants using red mud” (JOURNAL OF HAZARDOUS MATERIALS, ELSEVIER, AMSTERDAM, NL, vol. 160, no. 2-3, 30 December 2008 (2008-12-30), pages 589-593), the making of propellants using red mud. Beside red mud, which is present in a quantity between 20-60%, refractory waste is used in order to increase the aluminium content of the resulting product. Furthermore, other essential additives like kaolin and barium carbonate or calcium fluoride are used in order to obtain the required properties of the resulting propellants.

In CN103396784A, attempt has been made to produce low-density and high-strength proppant prepared from mixture of red mud (40-70 wt %), fly ash (0-30 wt %), bauxite (5-30 wt %) and auxiliary additives (1-15 wt %). The purpose of using bauxite and auxiliary additives is to achieve high strength proppant with the minimum closing pressure of 7,500 psi (52 MPa). Herein, in order to achieve homogenous mixing red mud is oven dried prior to mixing with other ingredients and the final mixture are grind to 325 mesh fine before pelletization. Drying red mud is not only practically difficult but also costlier making it commercially unviable.

In CN101575503A, attempt has been made to produce high-strength proppant for coarse oil prepared from mixture of red mud (1-20 wt %), fly ash (0-20 wt %), ceramic roller waste (60-85 wt %), manganese oxide or barium carbonate (0-5 wt %), dolomite (5-10 wt %) and ceramic clay (5-10 wt %). Herein, in order to achieve homogenous mixing red mud is oven dried prior to mixing with other ingredients and the final mixture are grind to fine powder before pelletization. Though the author claims the preparation method is simple and feasible, however, the practically difficult to emulate in industrial scale specially to find ceramic rollers with consistent chemical composition, making it impractical method.

In CN103304253A, attempt has been made to produce porous ceramic from red mud, fly ash and pore forming agent. The porous ceramic comprises 40-70 wt % of red mud, 5-40 wt % of coal ash, 10-30 wt % of a pore-forming agent, 1-5 wt % of an additive, and water which is 10-20% of the total weight of the materials. Again, for uniformly mixing the process involves drying red mud and re-adding water. The mixture then formed a shape, dried and roasted to prepare the porous ceramic material. The resulting ceramic material has high porosity with high bending resistance and open pore structure.

One of the closest inventions is CN105294142B. Here the author made attempt to produce lightweight aggregates from mixture of red mud, fly ash, gangue, silica fume, alkaline agent, nitration agent, carbonaceous pore former and granulating binder. Again, for uniformly mixing of all ingredients red mud must be dried, prior to mixing, blending and granulation. Furthermore, the invention involves usage of complex formulation involving expensive ingredients. It is a costlier, complex and impractical industrial approach making it commercially unviable.

Huifen, Y. et al describe in the article, “Utilization of Red Mud for the Preparation of Lightweight Aggregates” describes method to produce lightweight aggregates using red mud. Besides red mud other essential raw materials were glass waste and bentonite. Herein, to achieve homogenous mixing red mud is dried prior to mixing with other ingredients and the final mixture is grind finely before pelletization.

None of the above mentioned prior arts disclose about the lightweight sand particulates being produced majorly from bauxite residue and fly ash, which is a key feature of the present invention.

Substitution of natural sand with lightweight ceramic sand produced from two different industrial wastes i.e., bauxite residue and fly ash, supports protection of these habitats where natural sand is sourced. Based on the fact that major components in the present invention are waste by-products i.e., bauxite residue and fly ash, the raw materials are inexpensive making the man-made ceramic sand competitive and thus helps alleviate a waste disposal problem. Therefore, successful and economical manufacture of particulates from the mixture of bauxite residue and fly ash will not only reduce the impact of bauxite residue and fly ash disposals on the environment but also provide a great benefit to the economy.

The present invention overcomes the above mentioned problems through one step manufacturing process. It is a no surprise that despite hundreds of publications and patents there is not a single commercial technology which practically offers a solution to bauxite residue utilization.

The lightweight ceramic sand produced in the present invention offers the best alternative to natural sand, manufactured sand and lightweight fine aggregates.

### SUMMARY OF THE INVENTION

The key objective of the present invention is to provide a novel, improved, simple and economical method of engineered well-defined lightweight ceramic sand from combination of different industrial wastes.

Another objective of the present invention is to provide an alternative way of substituting natural sand, manufactured sand (also known as crushed stones) and lightweight fine aggregates to produce lightweight concrete, lightweight plasters, thermal insulating mortars and renders, and lightweight roof tiles.

Still another objective of the present invention is to manufacture the lightweight ceramic sand using mixture of partially dried bauxite residue and fly ash which are an undesirable by-product and/or wastage.

Further objective of the present invention is to manufacture in-situ size graded fine particulates at high throughput with partial drying of bauxite residue.

Still, further objective of the present invention is to manufacture in-situ size graded fine particulates at lowest manufacturing cost without involving sieving step.

The present invention discloses a novel, improved, simple and economic process for manufacturing new lightweight ceramic sand. The lightweight ceramic sand is produced from industrial wastes, wherein the major raw materials are fly ash, bauxite residue and/or biomass coal fly ash. The present invention relates to fabrication of fine particulates at high throughput and at very low manufacturing cost to compete against the fast-depleting natural sand including crushed stones and lightweight fine aggregates produced from expanded clay, expanded glass and volcanic activities.

The present invention is an improvement or a modification of the main invention disclosed in patent application Ser. No. 16/531,021, where main invention provides a novel method of manufacturing lightweight fine particulates comprising the steps of:
i. dry spraying of fly ash into moist bauxite residue cake while rotor and pan both are rotating;
ii. forming granules using high intensity shear-mixer;
iii. producing fine particulates with sand graded size gradation with sub-round shapes;
iv. drying the fine particulates using fluidized bed drying process;
v. sieving the dried particulates; and
vi. sintering the particulates of desired size gradation, shapes and strength at high temperature (1,015-1,275° C.).

The present invention discloses an improvement or a modification over above mentioned method for producing new lightweight ceramic sand suitable for the concrete and mortars production, comprising the steps of:
i. partial drying of bauxite residue cake;
ii. adding partially dried bauxite residue to fly ash while rotor and pan both are rotating;
iii. forming a plurality of granules by high intensity shear-mixer;
iv. producing a plurality of fine particulates with graded size gradation with sub-round shapes;
v. drying the plurality of fine particulates by fluidized bed drying process;
vi. sintering the plurality of fine particulates of desired size gradation, shapes and strength at high temperature (975-1,225° C.).

The modified method of producing new lightweight ceramic sand of the present invention provides multifold benefits to the end users which are described in details in the following pages of specification.

### BRIEF DESCRIPTION OF THE DRAWINGS

The accompanying drawings are included to provide a further understanding of the invention, and are incorporated in and constitute a part of the present invention and together with the description serve to explain the principle of the invention. In the drawings,

FIG. 1 shows process flow diagram of manufacturing new ceramic sand in accordance with an embodiment of the present invention.

FIG. 2 is a graph showing comparative data of a bulk density of new ceramic sand and former ceramic sand, respectively, in accordance with an embodiment of the present invention.

FIG. 3 is a graph showing comparative data of a particle density of new ceramic sand and former ceramic sand, respectively, in accordance with an embodiment of the present invention.

FIG. 4 is a graph showing comparative data of a thermal conductivity of new ceramic sand and former ceramic sand, respectively, in accordance with an embodiment of the present invention.

FIG. 5 is a graph showing comparative data of a dry hardened density of mortars produced from new ceramic sand and former ceramic sand, respectively, in accordance with an embodiment of the present invention.

FIG. 6 is a graph showing comparative data of a thermal conductivity of mortars produced from new ceramic sand and former ceramic sand, respectively, in accordance with an embodiment of the present invention.

Other objects, advantages and novel features of the invention will become apparent from the following description of the present embodiment when taken in conjunction with the accompanying drawings.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The present invention may be understood more readily by reference to the following detailed description of the invention taken in connection with the accompanying drawing figures, which forms a part of this disclosure. It is to be understood that this invention is not limited to the specific devices, methods, conditions or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that particular value unless the content clearly directs otherwise. Ranges may be expressed herein as from ‘about’ or ‘approximately’ another particular value when such a range is expressed another embodiment. Also, it will be understood that unless otherwise indicated, dimensions and material characteristics stated herein are by way of example rather than limitation and are for better understanding of sample embodiment of suitable utility, and variations outside of the stated values may also be within the scope of the invention depending upon the particular application.

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

It is to be understood that the term “partially dried bauxite residue” hereinafter refers to a bauxite residue with moisture content less than 15 wt %, the term “bauxite residue” hereinafter refers to a by-product produced during the production of alumina from bauxite ore (Bayer process), having at least rich iron oxide (35-52 wt %), alumina (10-20 wt %), silica (7-14 wt %), titanium oxide (3-12 wt %),lime (3-14 wt %) and sodium oxide (2-9 wt %), and the term “bauxite residue” is not restricted to the type of bauxite ore used in the Bayer process.

It is to be understood that the term “fly ash” hereinafter refers to a by-product produced during the burning of hard or brown coal by thermal power plants, having at least rich silica (28-69 wt %), alumina (6-26 wt %), iron oxide (3-19 wt %), lime (1-25 wt %) and LoI (2-15 wt %).

It is to be understood that the term “waste to energy ash (WTA)” hereinafter refers to ash which is derived from the fumes of the incineration process during the burning of municipality solid wastes, having at least silica (20-40 wt %), alumina (6-20 wt %), iron oxide (1-5 wt %), lime (12-40 wt %), aggregate sodium and potassium oxide (2-10 wt %) and LoI (2-12 wt %).

It is to be understood that the term “biomass-coal fly ash (BCA)” hereinafter refers to a by-product produced during the burning of a mixture of biomass and hard or brown coal, having at least silica (28-67 wt %), alumina (6-25 wt %), iron oxide (1-7 wt %), lime (3-22 wt %), aggregate sodium and potassium oxide (2-10 wt %) and LoI (2-12 wt %). BCA may need to screen to remove sandy and char materials before the granulation process. BCA can also be a desulphurized biomass-coal fly ash.

It is to be understood that the term “glass waste (GW)” hereinafter refers to a finely grinded mixture of glass bottles, jars, table ware, flat glass, windows, etc. having at least silica >65 wt %. The waste glass can either from soda-lime glass, borosilicate glass or the mixture of both soda-lime glass and borosilicate glass.

It is to be understood that the term “ceramic waste (CW)” hereinafter refers to a finely grinded ceramic tiles or ceramic waste, having at least silica (32-69 wt %), alumina (14-40 wt %), iron oxide (2-8 wt %), lime (2-8 wt %), aggregate sodium and potassium oxide (4-12 wt %) and LoI (1-10 wt %).

It is to be understood that the term “limestone waste (LW)” hereinafter refers to a finely grinded limestone waste, having at least 75 wt % combined CaO and MgO. The term “limestone waste” can also be the broadly used lime which refers to calcium-containing inorganic materials, in which carbonates, oxides and hydroxides of calcium, magnesium and silicon predominate.

It is to be understood that the term “lightweight aggregate” hereinafter refers to granular material of mineral origin having a particle density not exceeding 2,000 kg/m³ or a loose bulk density not exceeding 1,200 kg/m³. This is also the definition of lightweight aggregates according to the harmonized DIN EN 13055:2016.

It is to be understood that the term “new ceramic sand” hereinafter refers to ceramic sand of the present invention, produced with fly ash or partially dried bauxite residue as a primary raw material (≥51 wt %).

It is to be understood that the term “former ceramic sand” hereinafter refers to ceramic sand of the main invention, produced with bauxite residue as a primary raw material and fly ash as a secondary raw material.

It is to be also understood that the phraseology and terminology employed herein is for the purpose of description and not of limitation.

Embodiments will now be described in detail with reference to the accompanying drawings. To avoid unnecessarily obscuring the present disclosure, well-known features may not be described or substantially the same elements may not be redundantly described, for example. This is for ease of understanding.

The drawings and the following description are provided to enable those skilled in the art to fully understand the present disclosure and are in no way intended to limit the scope of the present disclosure as set forth in the appended claims.

In order to achieve a better understanding of the nature of the present invention a preferred embodiment of a method of producing new and/or improved lightweight ceramic sand will now be explained.

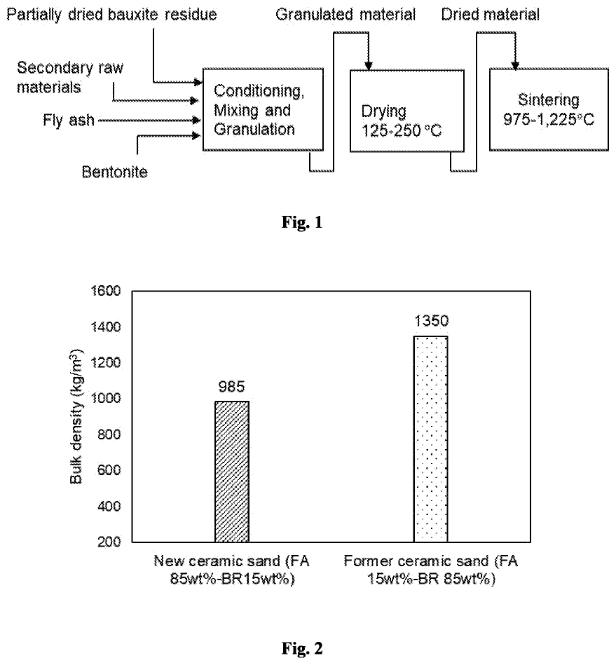

According to a preferred embodiment of the present invention, a process flow of manufacturing new and/or improved lightweight ceramic sand is shown in FIG. 1. The new ceramic sand is produced from a fly ash and a partially dried bauxite residue cake. The method comprises addition of the partially dried bauxite residue into the fly ash, wherein the partially dried bauxite residue is in the range of 49-1 wt % and the fly ash is in the range of 51-99 wt %. Further, granules are formed using a high intensity shear-mixer and then dried between temperature ranges from 125-250° C. The dried granules are sintered at high temperature in the range of about 975-1,225° C. The resultant product conform size gradation as per harmonized DIN 13139 (sand for mortars) and DIN EN 12620 (fine aggregates for concrete). Simultaneously, the resultant product also conform DIN EN 13055:2016 (lightweight aggregates for concrete and mortars).

The method of manufacturing lightweight ceramic sand comprises the following steps:
i. partial drying of the bauxite residue cake;
ii. adding the partially dried bauxite residue into the fly ash, while rotor and pan both are rotating;
iii. forming a plurality of granules by high intensity shear-mixer;
iv. producing a plurality of fine particulates with graded size gradation with sub-round shapes;
v. drying the plurality of fine particulates by a fluidized bed drying process; and
vi. sintering the plurality of dried fine particulates of desired size gradation, shapes and strength at high temperature to obtain new lightweight ceramic sand.

According to another embodiment of the present invention, the method utilizes the partially dried bauxite residue preferably between 48.5-1 wt %, fly ash between 51-95 wt %, and bentonite in the range between 8-0.1 wt %, before forming granules.

According to another embodiment of the present invention, the method utilizes biomass-coal fly ash preferably between 45-1 wt %, to be added into said fly ash between 51-95 wt %, and bentonite in the range between 8-0.1 wt %, before forming granules.

According to another embodiment of the present invention, the method utilizes the partially dried bauxite residue preferably between 51-99 wt %, fly ash between 49-0 wt %, and bentonite in the range between 8-0 wt %, before forming granules.

According to another embodiment of the present invention, the method utilizes addition of at least one raw material selected from, but not limited to waste-to-energy ash in range of 20-0 wt %, glass wastes in range of 15-0 wt %, ceramic wastes in range of 25-0 wt %, limestone wastes in range of 20-0 wt %, and a mixture thereof, before forming granules. The addition of waste-to-energy ash, glass wastes, ceramic wastes, limestone wastes, calcium carbonates can be done directly in high intensity shear-mixer or during the process of bauxite residue cake formation. The bauxite residue cake formation is a pressure filtration process where the bauxite residue slurry is dewatered from initial concentrations of between 30-44 wt % to produce final cakes containing up to 75 wt % solids.

According to another embodiment, the aforementioned method comprises the drying step wherein said drying is a fluidized bed drying between 125-250° C. The fine particulates can also be dried using a mesh belt dryer.

According to another embodiment, the aforementioned method further involves the step of high temperature sintering wherein the temperature can range between 975-1,225° C.

According to another embodiment, the aforementioned method involves the lightweight ceramic sand wherein the size of said lightweight ceramic sand range between, but not limited to 0 to 4 mm. Further, the size of said lightweight ceramic sand conforms to size gradation as per harmonized DIN EN 13139 (sand for plaster). In addition, the size of said lightweight ceramic sand conforms to lightweight aggregates definition as per harmonized DIN EN 13055:2016.

According to another embodiment, the bulk density of said lightweight ceramic sand is between, but not limited to 825 kg/m³ to 1,180 kg/m³. Also, the lightweight ceramic sand can be made further lighter by adding at least one expanding agent.

### Experimental Description

The below experimental details are provided to illustrate the working of the invention, and it should not be construed to limit the scope of the invention in any way.

The formulations are prepared as indicated in Table 1.

| | Major raw | | | | | | | | | |
|---|---|---|---|---|---|---|---|---|---|---|
| Formu- | material | | Other raw materials | | | | | Binder | | |
| lation | FA | BR | BCA | WTA | GW | CW | LW | Bentonite | Total | Water |
| No. | (wt %) | (wt %) | (wt %) | (wt %) | (wt %) | (wt %) | (wt %) | (wt %) | (wt %) | (wt %) |
| 1 | 51-95 | 49-1 | | | | | | 8-0.1 | 100 | 14-24 |
| 2 | 51-95 | 48.5-1 | | 20-0 | 15-0 | 25-0 | 20-0 | 8-0.1 | 100 | 14-24 |
| 3 | 51-95 | | 45-1 | 20-0 | 15-0 | 25-0 | 20-0 | 8-0.1 | 100 | 14-24 |
| 4 | 49-0 | 51-99 | 49-0 | 15-0 | 15-0 | 25-0 | 20-0 | 8-0 | 100 | 10-20 |

Tables 1 shows the various formulations with fly ash (FA) and bauxite residue (BR) as major raw materials while biomass-coal fly ash (BCA), waste-to-energy ash (WTA), glass waste (GW), ceramic waste (CW) and limestone waste (LW) as other input raw materials. The raw materials can be added one after the other and mixed simultaneously before adding the next raw material or raw materials can be added together and mixed at same time. No specific sequence of adding the raw material is to be followed.

The ratio of the combination for fly ash is 51-99 wt %, for partially dried bauxite residue is 49-1 wt %.

The ratio of the combination for fly ash is 51-98 wt %, for partially dried bauxite residue is 48.5-2 wt %, and for bentonite is 8-0.5 wt %.

The ratio of the combination for fly ash is 51-98 wt %, for biomass-coal fly ash is 48.5-2 wt %, and for bentonite is 8-0.5 wt %.

The ratio of the combination for fly ash is 49-0 wt %, for partially dried bauxite residue is 51-99 wt %, and for bentonite is 8-0 wt %.[0068] The above mentioned combinations can comprise at least one raw material selected from, but not limited to waste-to-energy ash in range of 20-0 wt %, glass wastes in range of 15-0 wt %, ceramic wastes in range of 25-0 wt %, limestone wastes in range of 20-0 wt %, and a mixture thereof, before forming granules.

Fly ash disposed into the high intensity shear-mixer. Partially dried bauxite residue, and/or bentonite added to the mixer while both rotor and pan are rotating. Simultaneously, waste to energy ash and/or ceramic waste and/or glass waste and/or limestone waste can be added while the rotor and pan are rotating. The blending and mixing is carried out for up to 60 seconds to ensure homogeneous mixing. To form granules, water quantity up to 20 wt % is added to the mixture. The addition of water is done under rotating condition of both rotor and pan. The rotation is carried out for 3-6 minutes. During the rotation procedure, the plurality of granules/spheres is formed. The granules thus obtained are herein referred to as sand precursor.

The moistened sand precursors are then dried using fluidized bed dryer. The residence time of fine particulates in the dryer depends upon several factors such as dryer's length, drying temperature, drying duration and air flow. For the experiment temperature of the dryer used in the range of about 125-250° C. and air feed between 650-1,500 m³/h and drying duration 2-7 minutes.

Dried sand precursors which have moisture between 5-10 wt % are fired in rotary kiln. The residence time of sand precursors in the kiln depends on several factors such as kiln length, temperature of the kiln which is in the range of about 975-1,225° C., chemical composition, particulate size, throughput and temperature of sand precursors. The size of lightweight sand particles produced are typically between 0 to 4 mm. The bulk density of the lightweight sand particulates is between 850 kg/m³ to 1,180 kg/m³. The density can be further reduced further by using expanding agent.

Also, the proportion of fly ash and bauxite residue is maintained to provide the advantage of ceramic sand over natural sand. By reversing the mixing ratio of partially dried bauxite residue and fly ash, the bulk density the particle density, and the thermal conductivity of new ceramic sand have been lowered and improved, which is described in the following examples:

### EXAMPLE 1

By reversing the mixing ratio of partially dried bauxite residue and fly ash, the bulk density of the new ceramic sand decreased to 985 kg/m³ compared to bulk density of the former ceramic sand i.e. 1350 kg/m³. The comparative data of the bulk density of the new ceramic sand and the former ceramic sand is shown in FIG. 2 of the present invention.

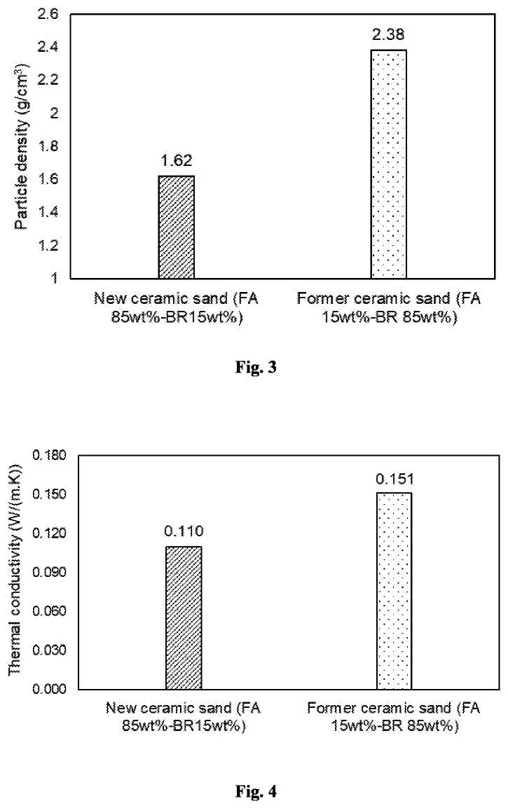

For the same mixing ratio, the particle density of the new ceramic sand reduced to 1.62 g/cm³ compared to the particle density of the former ceramic sand i.e. 2.38 g/cm³. The comparative data of the particle density of the new ceramic sand and the former ceramic sand is shown in FIG. 3 of the present invention.

Also with the same mixing ratio, the thermal conductivity of the new ceramic sand reduced to 0.11 W/m*K compared to the thermal conductivity of the former ceramic sand i.e. 0.15 W/m*K. The comparative data of the thermal conductivity of the new ceramic sand and the former ceramic sand is shown in FIG. 4 of the present invention.

The chemical composition of fly ash (FA) used in the Example 1 is as follows: silica 59 wt %, alumina 15 wt %, iron oxide 6%, other oxides 20 wt %, and LoI 0.8 wt %; and the chemical composition of bauxite residue is as follows: iron oxide 41 wt %, alumina 14.25 wt %, titanium oxide 11.2 wt %, silica 9.4 wt %, sodium oxide 4.9 wt %, and lime 3 wt %.

### EXAMPLE 2

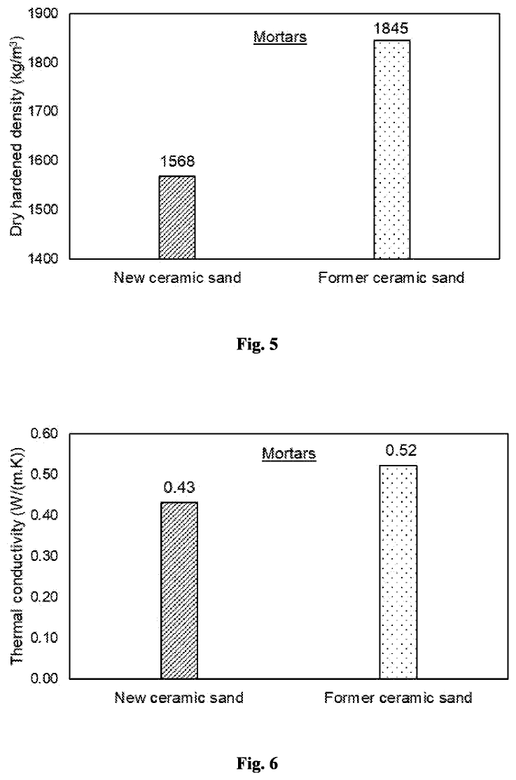

The dry hardened density of mortars produced from the new ceramic sand is 985 kg/m³ compared to the dry hardened density of mortars produced from the former ceramic sand i.e. 1350 kg/m³. The comparative data of the dry hardened density of mortars produced from the new ceramic sand and the former ceramic sand is shown in FIG. 5 of the present invention. The lower density of mortars will enhance speed of construction while that of concrete results in savings of steel and cement in buildings.

### EXAMPLE 3

The thermal conductivity of mortars produced from the new ceramic sand is 0.43 W/m*K compared to the thermal conductivity of mortars produced from the former ceramic sand i.e. 0.52 W/m*K. The comparative data of the thermal conductivity of mortars produced from the new ceramic sand and the former ceramic sand is shown in FIG. 6 of the present invention. The lower thermal conductivity of mortars and concrete produced from the new ceramic sand will further reduce CO₂ footprint from heating and/or cooling of buildings.

The novel method of present invention acknowledges various advantages by being more flexible with respect to the costs and availability of raw materials in the manufacturing locality. The proportion of fly ash and bauxite residue has been determined in such quantities which reduce raw material cost, mainly due to large distance transportation and ease of handling. The transportation of fly ash, which is a fine powder, requires special truck and need to pay transportation costs for both sides. However, bauxite residue which usually comes out in a cake form makes it relatively easier to handle and at the same time reduces transportation costs compared to transporting fly ash. The proportion of fly ash and bauxite residue can be adjusted relative to each other as per their availability in the manufacturing locality and prices. The proportion of fly ash and bauxite residue are also adjusted to ensure new lightweight ceramic sand also meets the harmonized DIN EN 13055:2016 (lightweight aggregates). The lightweight ceramic sand can be used as a building material.

The examples and embodiments shown above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A novel method of manufacturing lightweight ceramic sand, comprising:
(a) mixing a plurality of raw materials comprising at least one major raw material while simultaneous rotation of a rotor and a pan;
(b) mixing water to the mixture of step (a) and forming a plurality of granules by high intensity shear mixer;
(c) drying said plurality of granules to obtain a plurality of dried granules; and
(d) high temperature sintering of said plurality of dried granules thereby obtaining lightweight ceramic sand,
characterized in that, at least one major raw material is selected from fly ash and partially dried bauxite residue, preferably in range of 51-99 wt % and at least one raw material of the plurality of raw materials selected from, but not limited to biomass-coal fly ash, waste-to-energy ash, glass wastes, ceramic wastes, limestone wastes, and a mixture thereof, before forming granules.

2. The method as claimed in claim 1, wherein step (a) can comprise mixing of said fly ash in range of 51-95 wt % with said partially dried bauxite residue in range of 49-1 wt %.

3. The method as claimed in claim 1, wherein bentonite can be added before forming granules.

4. The method as claimed in claim 1, wherein step (a) can comprise mixing said partially dried bauxite residue in range of 51-99 wt % with said fly ash in range of 49-0.1 wt %.

5. The method as claimed in claim 3, wherein bentonite is in range of 8-0 wt %.

6. The method as claimed in claims 1 to 5, wherein the method comprises adding at least one raw material of the plurality of raw materials selected from, but not limited to biomass-coal fly ash in range of 45-1 wt %, waste-to-energy ash in range of 20-0 wt %, glass wastes in range of 15-0 wt %, ceramic wastes in range of 25-0 wt %, limestone wastes in range of 20-0 wt %, and a mixture thereof, before forming granules.

7. The method as claimed in claim 6, wherein addition of waste-to-energy ash, glass wastes, ceramic wastes, limestone wastes, calcium carbonates can be done directly in mixer or during the process of bauxite residue cake formation.

8. The method as claimed in claim 1, wherein said granules can be dried by a fluidized bed dryer in range of 125-250° C.

9. The method as claimed in claim 1, wherein said granules can be dried by a mesh belt dryer in the range of 125-250° C.

10. The method as claimed in claim 1, wherein said high temperature sintering is in range of 975-1,225° C.

11. A lightweight ceramic sand composition resulted from the method as claimed in claim 1 wherein, said composition comprises
a) the major raw material is selected from fly ash 51-99 wt % and/or bauxite residue 51-99 wt %;
b) other components is selected from biomass-coal fly ash in range of 1-45 wt %, waste-to-energy ash in range of 0.1-15 wt %, glass wastes in range of 0.1-15 wt %, ceramic wastes in range of 0.1-25 wt %, limestone wastes in range of 0.1-20 wt %;
c) binder is selected from bentonite 0.1-8 wt %.

11. The lightweight ceramic sand as claimed in claim 10, wherein size of said lightweight ceramic sand is in range of 0-4 mm.

12. The lightweight ceramic sand as claimed in claim 10, wherein a bulk density of said lightweight ceramic sand is in range of 750 kg/m³ to 1,180 kg/m³.

13. The lightweight ceramic sand as claimed in claim 10, wherein the physical and chemical characteristics of said lightweight ceramic sand conforms to lightweight aggregates definition as per harmonized DIN EN 13055:2016.

14. The lightweight ceramic sand as claimed in claim 10, wherein said lightweight ceramic sand are used as fine aggregate or lightweight fine aggregate for construction purposes and/or as sand for casting or molding purpose.
